(19) United States
(12) Patent Application Publication
(10) Pub. No.: US 2025/0367557 A1
(43) Pub. Date: Dec. 4, 2025

(54) VIRTUAL OBJECT SWITCHING METHOD AND APPARATUS, STORAGE MEDIUM AND ELECTRONIC DEVICE

(71) Applicant: NETEASE (HANGZHOU) NETWORK CO., LTD., Hangzhou (CN)

(72) Inventors: Jiajun FAN, Hangzhou (CN); Xiyu WANG, Hangzhou (CN); Bincheng XU, Hangzhou (CN)

(21) Appl. No.: 18/874,465

(22) PCT Filed: Oct. 28, 2022
(86) PCT No.: PCT/CN2022/128373

§ 371 Date: Dec. 12, 2024

(30) Foreign Application Priority Data
Jun. 15, 2022 (CN) 202210681910.5

(51) Int. Cl. A63F 13/56; A63F 13/2145; A63F 13/5258; A63F 13/5375; A63F 13/69; G06T 19/20

(52) U.S. Cl. CPC A63F 13/56; A63F 13/2145; A63F 13/5258; A63F 13/5375; A63F 13/69; G06T 19/20; G06T 2219/2016

(57) ABSTRACT

The present disclosure provides a virtual object switching method. The method includes: determining, in response to a control operation acting upon a function control, an operation direction corresponding to the control operation; determining, based on first position information of a locked first virtual object, a second virtual object according to the operation direction; and switching the locked first virtual object to the second virtual object.

### CROSS-REFERENCE TO RELATED APPLICATIONS

The present disclosure is a 371 national phase application of PCT Application PCT/CN2022/128373 filed Oct. 28, 2022, which claims priority to Chinese Patent Application No. 202210681910.5 filed on Jun. 15, 2022 and entitled “VIRTUAL OBJECT SWITCHING METHOD AND APPARATUS, STORAGE MEDIUM, AND ELECTRONIC DEVICE,” the entire contents of both of which applications are hereby incorporated by reference for all purposes.

### TECHNICAL FIELD

The present disclosure relates to the technical field of computers, and particularly relates to a virtual object switching method and a virtual object switching apparatus, a computer-readable storage medium, and an electronic device.

### BACKGROUND

With the popularization of mobile terminals, more and more mobile games have emerged. In mobile games, game players usually need to lock enemy virtual objects in order to attack the enemy virtual objects.

In some related arts, a game player may first touch a lock control to lock an enemy virtual object, and then touch the lock control again to randomly switch to another enemy virtual object that appears in the game interface and lock the enemy virtual object. However, this process of switching enemy virtual objects is random, resulting in the locked enemy virtual object being different from the game player's expectation, and may even switch to an enemy virtual object outside the game player's field of view, thereby reducing the accuracy of the enemy virtual object switched to and reducing the gaming experience of the game player.

In view of this, there is an urgent need in the art to develop a new virtual object switching method and apparatus.

It should be noted that the information disclosed in the above background part is only used to enhance the understanding of the background of the present disclosure, and therefore may include information that does not constitute the prior art known to those of ordinary skill in the art.

### SUMMARY

According to a first aspect, the present disclosure provides a virtual object switching method, and the method includes: determining, in response to a control operation acting upon a function control, an operation direction corresponding to the control operation, where the function control is located on a graphical user interface provided by a terminal device, the graphical user interface comprises at least a portion of a virtual scene and at least a portion of a virtual character, and the virtual character is a virtual object corresponding to the terminal device; determining, based on first position information of a locked first virtual object, a second virtual object according to the operation direction, where the locked first virtual object is a behavior target of the virtual character; and switching the locked first virtual object to the second virtual object.

According to a second aspect, the present disclosure provides a system, comprising one or more memories collectively containing one or more programs, and one or more processors, where the one or more processors are configured to, individually or collectively, perform the operations in the above method for virtual object switching.

According to a third aspect, the present disclosure provides one or more non-transitory computer-readable storage media containing, in any combination, computer program code that, when executed by a computer system, performs the operations in the above method for virtual object switching.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure. Apparently, the accompanying drawings described below are merely some embodiments of the present disclosure, and other accompanying drawings can further be obtained according to these accompanying drawings by those of ordinary skill in the art without creative labor.

FIG. 1 schematically shows a schematic flowchart of a virtual object switching method according to an embodiment of the present disclosure;

FIG. 2 schematically shows a schematic diagram of a graphical user interface in a virtual object switching method according to an embodiment of the present disclosure;

FIG. 3 schematically shows a schematic flowchart of determining a first virtual object in a virtual object switching method according to an embodiment of the present disclosure;

FIG. 4 schematically shows a schematic diagram of a game interface in a virtual object switching method according to an embodiment of the present disclosure;

FIG. 5 schematically shows a schematic flowchart of a virtual object switching method after a first virtual object is determined as a currently locked virtual object according to an embodiment of the present disclosure;

FIG. 6 schematically shows a schematic diagram of a graphical user interface in a virtual object switching method according to an embodiment of the present disclosure;

FIG. 7 schematically shows a schematic flowchart of determining a second virtual object in a virtual object switching method according to an embodiment of the present disclosure;

FIG. 8 schematically shows a schematic flowchart of determining a second virtual object in a virtual object switching method according to an embodiment of the present disclosure;

FIG. 9 schematically shows a schematic diagram of a graphical user interface in a virtual object switching method according to an embodiment of the present disclosure;

FIG. 10 schematically shows a schematic flowchart of determining a target region in a virtual object switching method according to an embodiment of the present disclosure;

FIG. 11 schematically shows a schematic diagram of a region ray in a virtual object switching method according to an embodiment of the present disclosure;

FIG. 12 schematically shows a schematic diagram of a target region in a virtual object switching method according to an embodiment of the present disclosure;

FIG. 13 schematically shows a schematic flowchart of determining a second virtual object in a virtual object switching method according to an embodiment of the present disclosure;

FIG. 14 schematically shows a schematic flowchart of determining a second virtual object in a virtual object switching method according to an embodiment of the present disclosure;

FIG. 15 schematically shows a schematic diagram of a sector region in a virtual object switching method according to an embodiment of the present disclosure;

FIG. 16 schematically shows a schematic diagram of an updated sector region in a virtual object switching method according to an embodiment of the present disclosure;

FIG. 17 schematically shows a schematic diagram of a sector region in a virtual object switching method according to an embodiment of the present disclosure;

FIG. 18 schematically shows a schematic flowchart of adjusting an attack direction in a virtual object switching method according to an embodiment of the present disclosure;

FIG. 19 schematically shows a schematic flowchart of adjusting a shooting angle in a virtual object switching method according to an embodiment of the present disclosure;

FIG. 20 schematically shows a schematic structural diagram of a virtual object switching apparatus according to an embodiment of the present disclosure;

FIG. 21 schematically shows an electronic device for a virtual object switching method according to an embodiment of the present disclosure; and

FIG. 22 schematically shows a computer-readable storage medium for a virtual object switching method according to an embodiment of the present disclosure.

### DETAILED DESCRIPTION

Example embodiments will now be described more fully with reference to the accompanying drawings. However, the example embodiments can be implemented in many forms and should not be construed as limited to the examples set forth herein; rather, these embodiments are provided so that the present disclosure will be more thorough and complete and will fully convey the concept of the example embodiments to those skilled in the art. The described features, structures, or characteristics may be combined in any suitable manner in one or more embodiments. In the following description, numerous specific details are provided in order to give a thorough understanding of embodiments of the present disclosure. However, those skilled in the art will appreciate that the technical solutions of the present disclosure may be practiced while omitting one or more of the specific details, or other methods, components, apparatuses, steps, and the like may be adopted. In other instances, well-known technical solutions are not shown or described in detail to avoid overshadowing and obscuring aspects of the present disclosure.

The terms “a”, “an”, “the” and “said” used in this specification are used to indicate the presence of one or a plurality of elements/components/and the like. The terms “including” and “having” are used to indicate an open-ended inclusion and mean that additional elements/components/and the like may exist in addition to the listed elements/components/and the like. The terms “first,” “second,” and the like are used only as labels and are not intended to limit the quantity of their objects. These terms are merely used to differentiate information of a same type. For example, without departing from the scope of the present disclosure, first information is also referred to as second information, and similarly the second information is also referred to as the first information. The term “and/or” used in the present disclosure refers to any or all of possible combinations including one or more associated listed items. Depending on the context, for example, the term “if” used herein may be explained as “when” or “while”, or “in response to . . . , it is determined that”.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Additionally, the drawings are merely schematic illustrations of the present disclosure and are not necessarily drawn to scale. The same reference numerals in the drawings denote the same or similar parts, and thus their repeated description will be omitted. Some of the blocks shown in the drawings are functional entities, which do not necessarily correspond to physically or logically separate entities.

A virtual object switching method in one embodiment of the present disclosure may be performed on a local terminal device or a server. When the virtual object switching method runs on a server, the information processing method may be implemented and performed based on a cloud interaction system, where the cloud interaction system includes a server and a client device.

In some embodiments, various cloud applications, such as cloud gaming, may be run under the cloud interaction system. Take the cloud gaming as an example, the cloud gaming refers to a gaming method based on cloud computing. In the cloud gaming running mode, a game program running entity and a game picture presentation entity are separated. The storage and operation of the virtual object switching method are completed on a cloud gaming server. The client device is used for receiving and sending data and presenting a game picture. For example, the client device may be a display device with data transmission function close to the user side, such as a mobile terminal, a TV, a computer, and a PDA. However, the cloud gaming server in the cloud is responsible for information processing. When playing a game, a player operates the client device to send operation instructions to the cloud gaming server. The cloud gaming server runs the game according to the operation instructions, encodes and compresses the game picture and other data, and returns it to the client device through a network. Finally, the client device decodes and outputs the game picture.

In some embodiments, taking a game as an example, a local terminal device stores a game program and is used for presenting the game picture. The local terminal device is used for interacting with a player through a graphical user interface, that is, downloading and installing the game program and running it in a conventional manner through an electronic device. The local terminal device may provide the graphical user interface to the player in a variety of manners including, for example, rendering and displaying it on a display screen of the terminal, or providing it to the player through holographic projection. For example, the local terminal device may include a display screen and a processor. The display screen is used for presenting a graphical user interface, the graphical user interface including a game picture. The processor is used for running the game, generating the graphical user interface, and controlling display of the graphical user interface on the display screen.

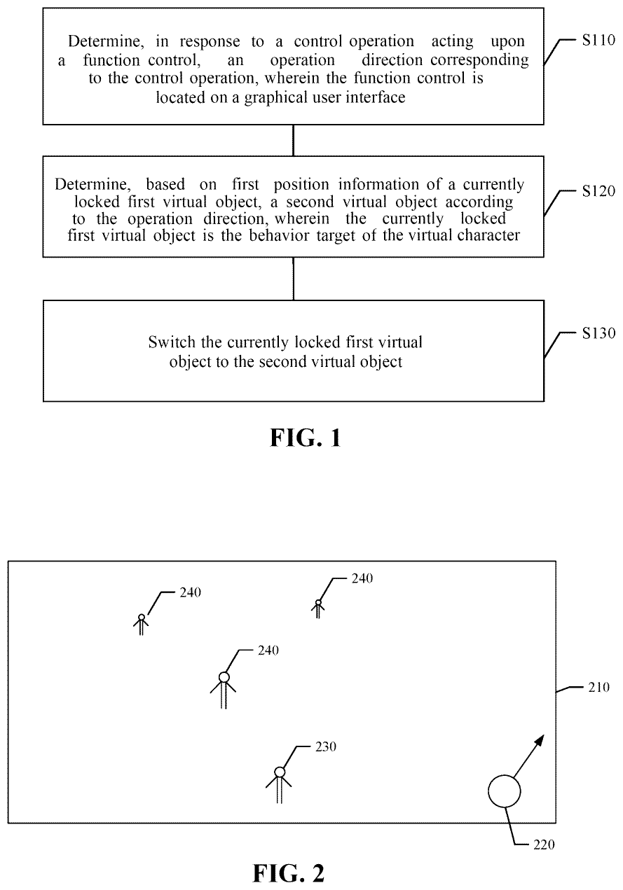

In view of the problems existing in the related art, the present disclosure proposes a virtual object switching method. FIG. 1 is a schematic flowchart of a virtual object switching method. As shown in FIG. 1, the virtual object switching method at least includes the following steps:

Step S110. Determine, in response to a control operation acting upon a function control, an operation direction corresponding to the control operation, where the function control is located on a graphical user interface.

Step S120. Determine, based on first position information of a currently locked first virtual object, a second virtual object according to the operation direction, where the currently locked first virtual object is the behavior target of the virtual character.

Step S130. Switch the currently locked first virtual object to the second virtual object.

In the method and apparatus provided by the example embodiments of the present disclosure, on the one hand, the second virtual object is determined according to the operation direction based on the first position information of the currently locked first virtual object, the situation in the prior art that a virtual object is randomly locked but the randomly locked virtual object is not the user's intended locked object is avoided, thereby improving user experience. On the other hand, the second virtual object is determined based on the first position information and the operation direction, based on which the second virtual object is related to the operation direction and the first position information, thereby improving the accuracy of the determined second virtual object, and avoiding the situation in the prior art of switching to a virtual object outside the field of view of the virtual object.

The various steps of the virtual object switching method are described in detail below.

In the step S110, the operation direction corresponding to the control operation is determined in response to the control operation acting upon the function control, where the function control is located on the graphical user interface.

In an example embodiment of the present disclosure, the function control refers to a control displayed in the graphical user interface provided by a terminal device. The terminal device may be the local terminal device mentioned above, or may be the client device in the cloud interaction system mentioned above.

Specifically, the function control may be used for locking a certain enemy virtual object in a virtual scene, and may also be used for switching from one enemy virtual object to another enemy virtual object.

The control operation refers to an operation acting upon a function control and having an operation direction. Specifically, the control operation may be a sliding operation acting upon the function control, or may be any operation having an operation direction, which is not specifically limited in this example embodiment.

When the control operation is performed on the function control, it means that a currently locked virtual object needs to be switched from the first virtual object to the second virtual object.

For example, FIG. 2 schematically shows a schematic diagram of a graphical user interface. As shown in FIG. 2, an interface 210 is a graphical user interface, a control 220 is a function control, an object 230 is a virtual object corresponding to a virtual character, and an object 240 is the behavior target of the virtual object, that is, an enemy virtual object. For example, in a shooting game, the virtual object is a virtual object corresponding to a user, and the object 240 may be an enemy virtual object shot by the virtual object.

Based on this, when the user performs a control operation acting upon the control 220, a determined operation direction corresponding to the sliding operation is shown by an arrow in FIG. 2.

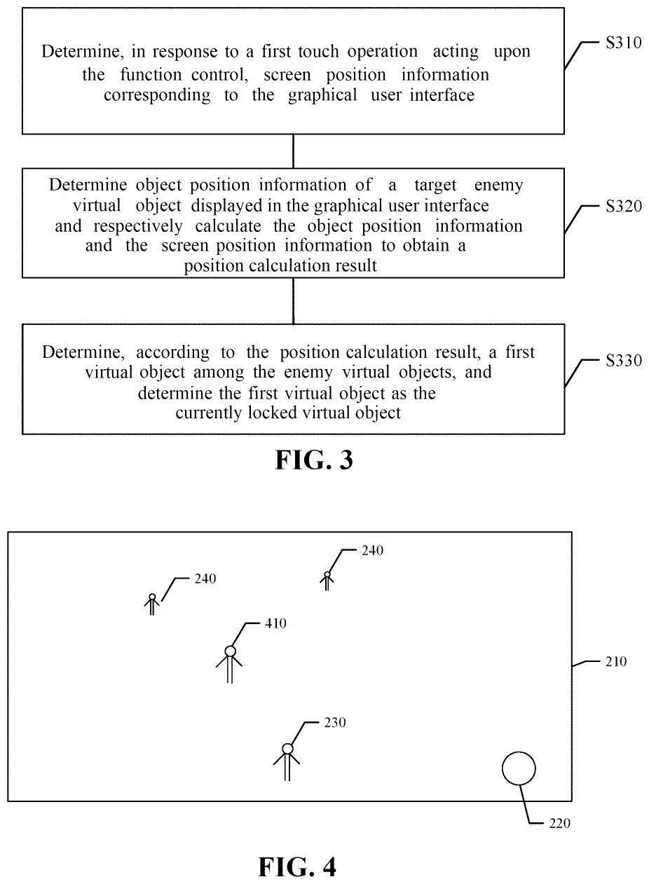

FIG. 3 shows a schematic flowchart of determining a first virtual object in a virtual object switching method. As shown in FIG. 3, the method includes at least the following steps: in step S310, screen position information corresponding to the graphical user interface is determined in response to a first touch operation acting upon the function control.

The first touch operation refers to an operation acting upon the function control and used for locking the first virtual object. Moreover, the first touch operation is different from the control operation, and it does not have an operation direction. Specifically, the first touch operation may be a click operation, a double-click operation, or a long press operation, which is not specifically limited in this example embodiment.

The screen position information may be specific position information in the graphical user interface, for example, position information of the exact center of the graphical user interface, character position information of the virtual character in the virtual scene, or crosshair position information, which is not specifically limited in this example embodiment.

For example, when the user performs a click operation acting upon the function control, the screen position information corresponding to the graphical user interface is determined to be (15, 3).

In step S320, object position information of an enemy virtual object displayed in the graphical user interface is determined, and the object position information and the screen position information are respectively calculated to obtain a position calculation result.

The enemy virtual object corresponds to the enemy virtual character, and the enemy virtual character is the behavior target of the virtual character.

The enemy virtual object refers to the behavior target of the virtual object, and correspondingly, the object position information is interface coordinates of the enemy virtual object displayed on the graphical user interface. After the object position information and the screen position information are obtained, the object position information and the screen position information need to be calculated to determine the first virtual object that is closest to the screen position information.

For example, FIG. 4 schematically shows a schematic diagram of a game interface. As shown in FIG. 4, when the user clicks the function control 220, it is determined that enemy virtual object displayed in the graphical user interface includes two enemy virtual objects 240 and one enemy virtual object 410, and then, it is determined that object position information corresponding to the enemy virtual object 410 is (12, 20), object position information corresponding to one of the enemy virtual objects 240 is (17, 40), and object position information corresponding to the other enemy virtual object 240 is (10, 37).

Based on this, the object position information (12, 20) and the screen position information (15, 3) are calculated to obtain a position calculation result, the object position information (12, 20) and the screen position information (15, 3) are also calculated to obtain a position calculation result, and the object position information (10, 37) and the screen position information (15, 3) are also calculated to obtain a position calculation result.

In step S330, a first virtual object is determined from the enemy virtual objects according to the position calculation results, and the first virtual object is determined as the currently locked virtual object.

Based on the position calculation results, the first virtual object is determined from the enemy virtual objects. It is worth noting that the determined first virtual object is closest to the screen position information, and after the first virtual object is determined, the first virtual object is determined as the currently locked virtual object. Then, when the control operation is performed on the function control subsequently, the currently locked virtual object may be switched from the first virtual object to a second virtual object.

For example, as shown in FIG. 4, the enemy virtual object 410 is the first virtual object.

In this example embodiment, before performing the control operation on the function control, it is necessary to first determine the first virtual object, which lays a foundation for subsequently switching the currently locked virtual object from the first virtual object to the second virtual object.

In some embodiments, the screen position information includes position information corresponding to the center of the graphical user interface, crosshair position information, and character position information corresponding to the virtual character.

The crosshair position information refers to position information of the firing position of the weapon used for attack when an enemy virtual object is attacked. The character position information refers to position information of the virtual character in the virtual scene.

For example, the screen position information may be position information (100, 100) corresponding to the center of the graphical user interface, the screen position information may be crosshair position information (50, 75), or the screen position information may be character position information (15, 37) of the virtual character.

In this example embodiment, the screen position information includes the position information corresponding to the center of the graphical user interface, the crosshair position information, and the character position information corresponding to the virtual character, which increases the flexibility of determining the first virtual object according to the screen position information.

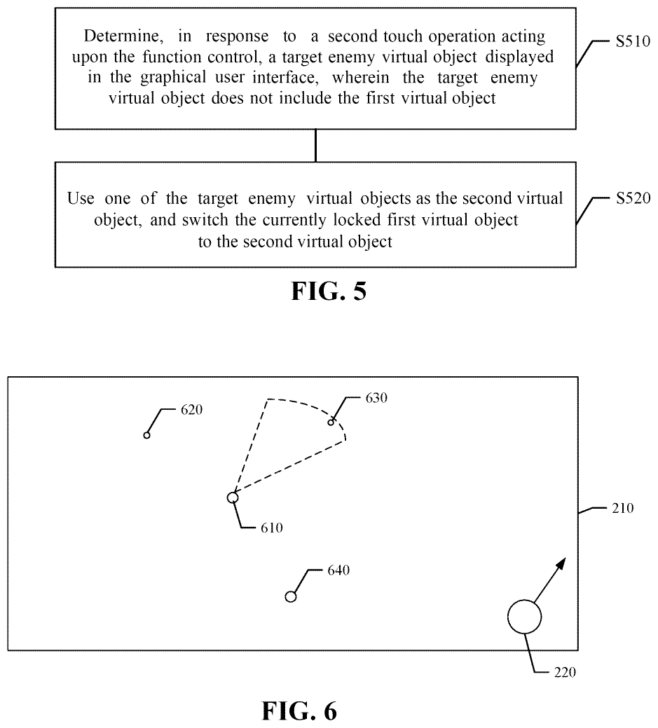

FIG. 5 shows a schematic flowchart of a virtual object switching method after the first virtual object is determined as the currently locked virtual object. As shown in FIG. 5, the method includes at least the following steps: in step S510, a target enemy virtual object displayed in the graphical user interface is determined in response to a second touch operation acting upon the function control, where the target enemy virtual object does not include the first virtual object.

After the first virtual object is determined as the currently locked virtual object, if the user further performs the second touch operation acting upon the function control, a second virtual object will be randomly determined to switch the currently locked virtual object from the first virtual object to the second virtual object.

In the process of randomly determining the second virtual object, it is first necessary to determine a target enemy virtual object displayed in the graphical user interface. It is worth noting that the target enemy virtual object does not include the first virtual object.

For example, as shown in FIG. 4, at this time the first virtual object is the object 410. When the user clicks on the function control 220, the quantity of determined target enemy virtual objects is two. Specifically, the target enemy virtual objects are the objects 240.

In step S520, one of the target enemy virtual objects is used as the second virtual object, and the currently locked first virtual object is switched to the second virtual object.

One of the target enemy virtual objects is randomly selected as the second virtual object, and the currently locked virtual object is switched from the first virtual object to the second virtual object.

For example, as shown in FIG. 4, the quantity of the target enemy virtual objects is two, specifically, the target enemy virtual objects are the objects 240, and then, one of the two target enemy virtual objects may be randomly determined as the second virtual object to switch the currently locked virtual object from the first virtual object to the second virtual object.

In this example embodiment, after the first virtual object is determined, when the user performs the second touch operation acting upon the function control, one of the target enemy virtual objects is selected as the second virtual object to switch the currently locked first virtual object to the randomly selected second virtual object.

In the step S120, the second virtual object is determined according to the operation direction based on the first position information corresponding to the currently locked first virtual object, where the currently locked first virtual object is the behavior target of the virtual character.

In an example embodiment of the present disclosure, the first position information refers to display coordinates of the first virtual object in the graphical user interface. A second virtual object may be determined based on the first position information and the operation direction, so that the currently locked virtual object can be subsequently switched from the first virtual object to the second virtual object.

For example, FIG. 6 schematically shows a schematic diagram of a graphical user interface. As shown in FIG. 6, a position 610 is the position of the first virtual object in the graphical user interface, that is, the first position information, a position 620 is a display position of the behavior target of a virtual object displayed in a game interface, a position 630 is a display position of another behavior target of the virtual object displayed in the game interface, and a position 640 is a display position of the virtual object displayed in the graphical user interface. A sector region shown in FIG. 6 is a target region determined according to the position 610 and the operation direction. Based on this, the object at the position 630 in the target region is the second virtual object.

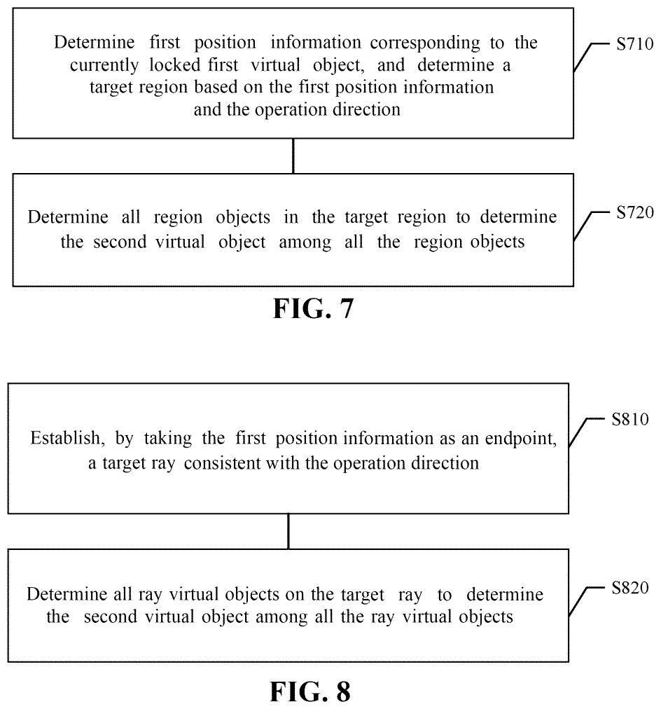

FIG. 7 shows a schematic flowchart of determining a second virtual object in a virtual object switching method. As shown in FIG. 7, the method includes at least the following steps: in step S710, first position information corresponding to the currently locked first virtual object is determined, and a target region is determined based on the first position information and the operation direction.

The target region refers to a region determined according to the first position information and the operation direction. Specifically, the target region may be a sector region, the target region may be a rectangular region, or the target region may further be a region of any shape, which is not specifically limited in this example embodiment.

For example, as shown in FIG. 6, the position 610 is the first position information, the arrow is the operation direction, and the sector region formed by dotted lines in FIG. 6 is a region determined based on the first position information and the operation direction.

In step S720, all region objects in the target region are determined to determine the second virtual object among all the region objects.

The region object refers to an enemy virtual object in the target region.

For example, as shown in FIG. 6, the sector region formed by the dotted lines is the target region. Obviously, the enemy virtual object at the position 630 in the target region is the region object.

In this example embodiment, the target region is determined based on the first position information and the operation direction, and the second virtual object is determined among all the region objects in the target region, thereby improving the accuracy of the determined second virtual object and avoiding the situation that the second virtual object is not within the field of view of the virtual object.

FIG. 8 shows a schematic flowchart of determining a second virtual object in a virtual object switching method. As shown in FIG. 8, the method includes at least the following steps: in step S810, a target ray consistent with the operation direction is established by taking the first position information as an endpoint.

In addition to determining the second virtual object in the target region, the second virtual object may also be determined according to the target ray. The target ray refers to a ray consistent with the operation direction and established with the first position information as an endpoint.

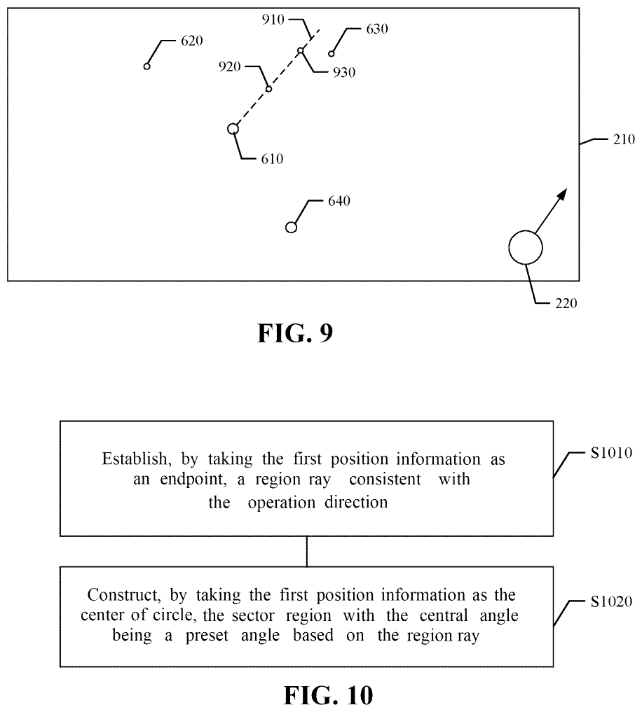

For example, FIG. 9 schematically shows a schematic diagram of a graphical user interface. As shown in FIG. 9, a ray 910 is a target ray based on first position information 610 and consistent with an operation direction (that is, an arrow direction in FIG. 9), there is an enemy virtual object at a position 920, and there is also an enemy virtual object at a position 930.

In step S820, all ray virtual objects on the target ray are determined to determine the second virtual object among all the ray virtual objects.

The position where the ray virtual object is located overlaps the target ray.

For example, as shown in FIG. 9, the enemy virtual object at the position 920 and the enemy virtual object at the position 930 are all ray virtual objects, and thus, the enemy virtual object at the position 920 may be determined as the second virtual object.

In this example embodiment, the second virtual object may also be a ray virtual object on the target ray, and because the target ray is the ray consistent with the operation direction and established by taking the first position information as the endpoint, the accuracy of the determined second virtual object is improved, thereby avoiding the situation that the second virtual object is not within the field of view of the virtual object.

FIG. 10 shows a schematic flowchart of determining a target region in a virtual object switching method, and the target region includes a sector region. As shown in FIG. 10, the method includes at least the following steps: in step S1010, a region ray consistent with the operation direction is established by taking the first position information as an endpoint.

The target region may be specifically a sector region. When determining the sector region, the region ray needs to be used. The region ray refers to a ray that takes the first position information as the endpoint and is consistent with the operation direction.

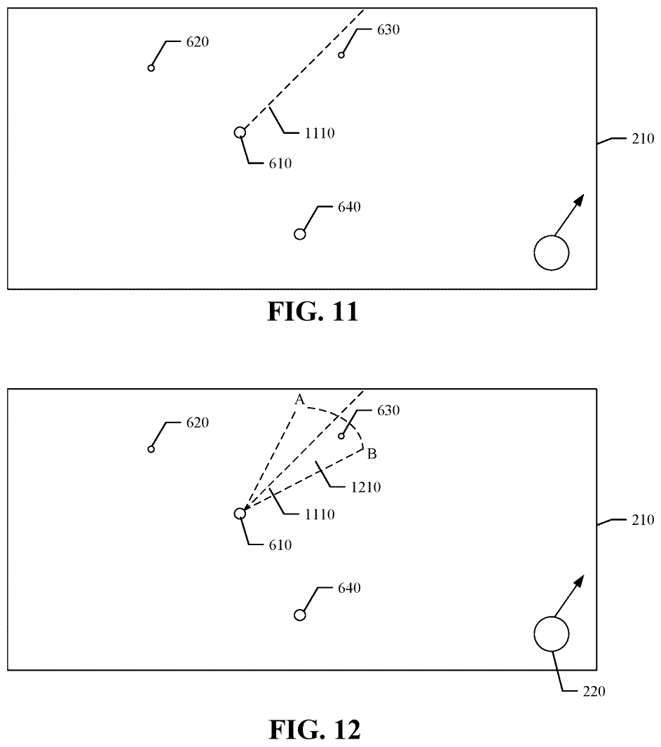

For example, FIG. 11 schematically shows a schematic diagram of a region ray. It is worth noting that the user will not see the region ray in the terminal. As shown in FIG. 11, a ray 1110 is the region ray, and an endpoint of the ray 1110 is at the position 610, that is, at the first position information where the first virtual object is displayed in the graphical user interface, and the direction of the ray 1110 is consistent with the operation direction indicated by an arrow.

In step S1020, by taking the first position information as the center of circle, the sector region with the central angle being a preset angle is constructed based on the region ray.

The preset angle refers to a preset angle value of a central angle of a sector region. Based on the preset angle and the region ray, a sector region can be constructed. The sector region is the target region. It is worth noting that the region ray divides the sector region into two parts.

For example, FIG. 12 schematically shows a schematic diagram of the target region. It is worth noting that the target region will not be displayed on the user interface. As shown in FIG. 12, a region 1210 composed of the position 610 represented by the first position information, a point A, and a point B is the sector region. Obviously, the region ray 1110 divides the sector region 1210 into two parts.

In this example embodiment, with the first position information as the center of circle, the sector region with the central angle being the preset angle is constructed based on the region ray. The direction of the region ray is consistent with the operation direction, thereby ensuring that the determined target region corresponds to the control operation of the user, and further ensuring the accuracy of the subsequently determined second virtual object, avoiding the situation in the prior art of switching to the second virtual object outside the field of view of the virtual object, and improving the gaming experience of the user.

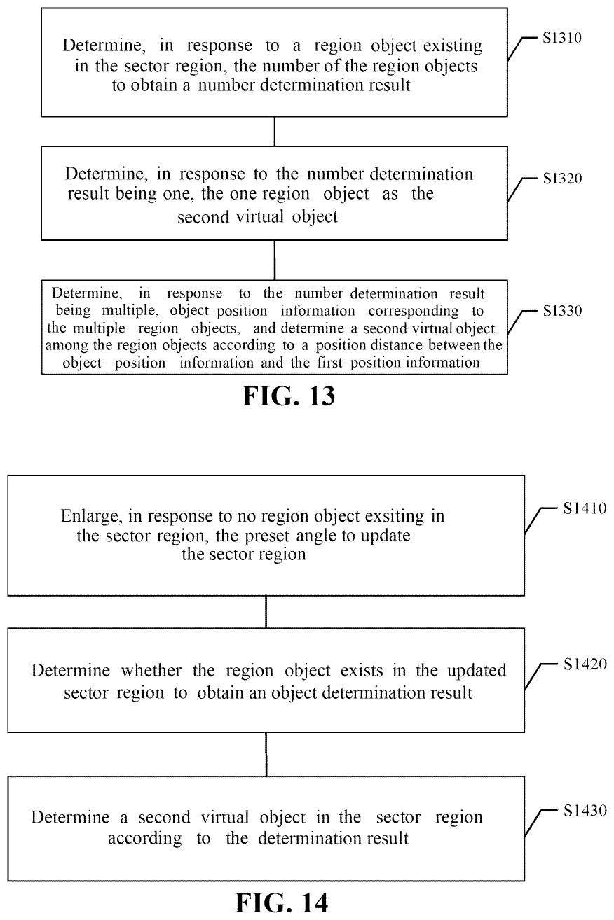

FIG. 13 shows a schematic flowchart of determining a second virtual object in a virtual object switching method. As shown in FIG. 13, the method includes at least the following steps: In step S1310, in response to a region object existing in the sector region, the number of region objects is determined to obtain a number determination result.

The region object refers to an enemy virtual object that may exist in the sector region. When there is a region object in the sector region, the number of region objects existing in the sector region is determined to obtain the number determination result.

For example, as shown in FIG. 12, in the sector region 1210, it is apparent that there is one region object, that is, the enemy virtual object displayed at the position 630.

In step S1320, in response to the number determination result being one, the one region object is determined as the second virtual object.

In response to the number determination result being one, the one region object is determined as the second virtual object.

For example, as shown in FIG. 12, in the sector region, there is one region object, that is, the virtual object displayed at the position 630, and the enemy virtual object displayed at the position 630 is determined as the second virtual object.

In step S1330, in response to the number determination result being multiple, object position information corresponding to the multiple region objects is determined, and a second virtual object is determined among the region objects according to a position distance between the object position information and the first position information.

If there are multiple region objects in the sector region, object position information corresponding to the multiple region objects is determined, and a second virtual object is determined among the region objects according to the position distance between the object position information and the first position information.

For example, if there are two region objects, namely a region object X1 and a region object X2, after object position information (25, 24) corresponding to the region object X1 is determined, it is also necessary to determine object position information (40, 35) corresponding to the region object X2.

Position distances between the multiple pieces of object position information and the first position information are calculated respectively, and a region object closest to the first virtual object is selected as the second virtual object according to the position distances.

For example, the first position information is (22, 20), then it is necessary to calculate a position distance between the first position information (22, 20) and the object position information (25, 24), and it is also necessary to calculate a position distance between the first position information (22, 20) and the object position information (40, 35). Based on this, it is determined that the region object X1 is the second virtual object.

In this example embodiment, in response to the number determination result being one, the one region object is determined as the second virtual object. in response to the number determination result being multiple, a second virtual object is determined from the multiple region objects according to the position distances. On the one hand, the logic of determining the second virtual object is improved; on the other hand, it ensures that the determined second virtual object is in the target region, thereby improving the accuracy of the determined second virtual object, avoiding the situation in the prior art that the second virtual object is outside the field of view of the virtual object, and improving the gaming experience of the user.

FIG. 14 shows a schematic flowchart of determining a second virtual object in a virtual object switching method. As shown in FIG. 14, the method includes at least the following steps: in step S1410, in response to no region object existing in the sector region, the preset angle is enlarged to update the sector region.
in response to no region object existing in the sector region, the preset angle is enlarged to update the area of the sector region.

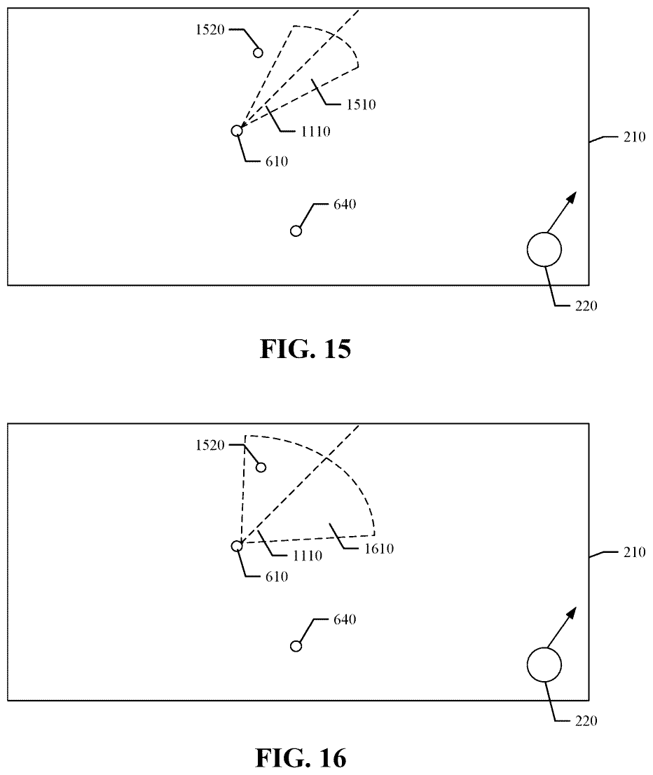

For example, FIG. 15 schematically shows a schematic diagram of a sector region. It is worth noting that the shape of the sector region is not displayed in the terminal, and therefore, it is represented by dotted lines. As shown in FIG. 15, an enemy virtual object 1520 does not exist in a sector region 1510. Therefore, there is no region object in the sector region 1510. At this time, the preset angle needs to be enlarged to update the sector region. For example, the preset angle of the sector region may be enlarged to twice the original angle.

FIG. 16 schematically shows a schematic diagram of an updated sector region. It is worth noting that the shape of the sector region is not displayed in the terminal, and therefore, it is represented by dotted lines. As shown in FIG. 16, a region 1610 is the updated sector region.

In step S1420, it is determined whether a region object exists in the updated sector region to obtain an object determination result.

It is determined whether a region object exists in the updated sector region to obtain the object determination result.

For example, as shown in FIG. 16, it is determined whether a region object exists in the updated sector region 1610 to obtain a determination result.

In step S1430, according to the determination result, a second virtual object in the sector region is determined.

According to the determination result, the second virtual object is determined in the updated sector region.

For example, as shown in FIG. 16, it is obvious that the determination result is that a region object 1520 exists in the updated sector region 1610, and the region object 1520 is determined as the second virtual object.

In this example embodiment, if the sector region does not include a region object, the preset angle is enlarged to improve the logic of determining the second virtual object to ensure that the second virtual object can be determined.

In some embodiments, the enlarging, in response to no region object existing in the sector region, the preset angle to update the sector region includes: incrementing the preset angle according to a preset angle increment parameter to update the sector region.
in response to no region object existing in the sector region, the preset angle needs to be enlarged. Furthermore, the preset angle is enlarged incrementally according to the preset angle increment parameter. The preset angle increment parameter may be a specific increment value or a parameter in a formula for calculating an increment angle, which is not specifically limited in this example embodiment.

For example, if the preset angle increment parameter is 30 degrees, the preset angle is incremented by 30 degrees. Specifically, when an initial angle of the sector region is 35 degrees, if no region object exists in the target region, the angle of the sector region is enlarged to 65 degrees. If still no region object exists in the enlarged sector region, the angle of the sector region is enlarged to 95 degrees, and so on, until a region object exists in the sector region.

In this example embodiment, in response to no region object existing in the sector region, the preset angle is incremented according to the preset angle increment parameter to ensure that the second virtual object can be determined, thereby avoiding the logic of being unable to determine the second virtual object.

In some embodiments, the method further includes: changing, in response to the enlarged preset angle meeting a preset angle condition and no region object existing in the sector region corresponding to the enlarged preset angle, the direction of the region ray from being consistent with the operation direction to being opposite to the operation direction to update the region ray.

The preset angle condition refers to a condition that the enlarged preset angle may meet, and when the enlarged preset angle meets the preset angle condition, it means that there is no region object in the field of view consistent with the sliding direction at this time, and then, the direction of the region ray is changed to a direction opposite to the sliding direction to update the region ray. Based on the updated region ray, a new sector region continues to be created to determine the second virtual object in the sector region.

Specifically, the preset angle condition may be a condition that the enlarged preset angle is greater than a certain angle value, which is not specifically limited in this example embodiment.

If there is no region object in the newly created sector region, the preset angle may be incremented according to the preset angle increment parameter until the second virtual object is determined.

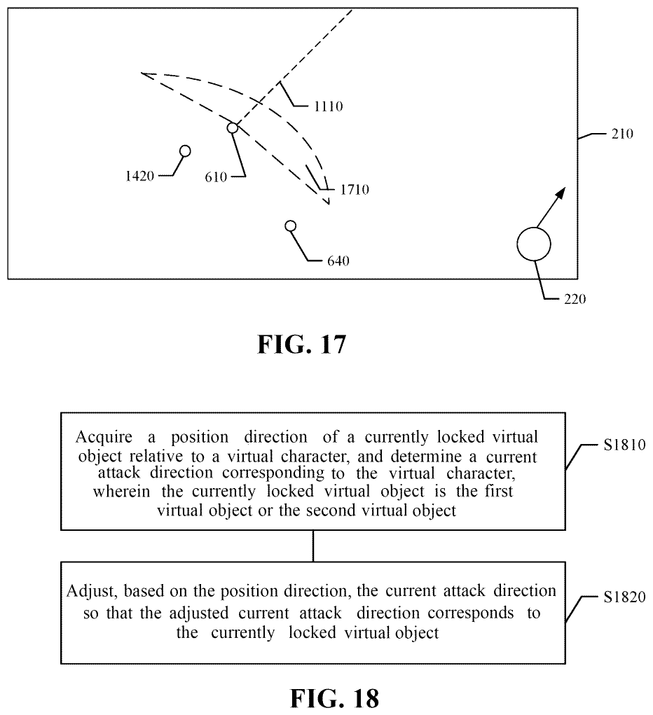

For example, FIG. 17 schematically shows a schematic diagram of a sector region. It is worth noting that the shape of the sector region is not displayed in the terminal, and therefore, it is represented by dotted lines. As shown in FIG. 17, the preset angle of a sector region in a region 1710 is greater than an angle threshold of 180°, and there is still no region object in the region 1710, then the direction of the region ray is changed to the direction opposite to the operation direction.

In some embodiments, if the enlarged preset angle is greater than the angle threshold and there is no region object in the sector region corresponding to the enlarged preset angle, the direction of the region ray is changed to the direction opposite to the operation direction to ensure that when there is no region object in the field of view corresponding to the virtual object, the second virtual object can be determined in the subsequent process, thereby improving the logic for determining the second virtual object.

In step S130, the currently locked first virtual object is switched to the second virtual object.

In an example embodiment of the present disclosure, the second virtual object in the target region is determined, and the first virtual object is switched to the second virtual object, that is, the currently locked virtual object is no longer the first virtual object, but the second virtual object.

Furthermore, after the currently locked virtual object is locked, if the user performs a game perspective conversion operation, the game perspective conversion operation may not be responded to, so as to ensure that the locked virtual object is always in a position that the user can directly attack. In some embodiments, the game perspective conversion operation may be responded to, and, when the game perspective conversion operation ends, a shooting angle of a virtual camera is restored to the position before the game perspective conversion operation to ensure that the locked virtual object is always in the position that the user can directly attack.

For example, as shown in FIG. 16, the second virtual object in a target region 1610 is determined to be a virtual object X3 displayed at a position 1520. Based on this, the virtual object X3 is determined to be the second virtual object. At this time, the currently locked virtual object is switched from the first virtual object to the second virtual object.

FIG. 18 shows a schematic flowchart of adjusting an attack direction in a virtual object switching method. As shown in FIG. 18, the method includes at least the following steps: in step S1810, a position direction of the currently locked virtual object relative to the virtual character is acquired, and a current attack direction corresponding to the virtual character is determined, where the currently locked virtual object is the first virtual object or the second virtual object.

The position direction refers to a direction of the position where the currently locked virtual object is located relative to the position where the virtual character is located.

For example, if the currently locked enemy virtual object is the first virtual object, the position direction is the direction of the first virtual object relative to the virtual character; and if the currently locked enemy virtual object is the second virtual object, the position direction is the direction of the second virtual object relative to the virtual character.

In step S1820, the current attack direction is adjusted based on the position direction so that the adjusted current attack direction corresponds to the currently locked virtual object.

The current attack direction is the direction in which the virtual character currently attacks the enemy virtual character. By adjusting the current attack direction according to the position direction, it can be ensured that the attack object of the virtual character at this time is the currently locked virtual object.

For example, the position direction is a due south direction, and the current attack direction is a south-west direction. Based on this, the current attack direction is adjusted to the due south direction.

In this example embodiment, the current attack direction is adjusted based on the position direction, thereby ensuring that the attack object of the current virtual character is the currently locked virtual object, providing convenience for the virtual character to attack, and optimizing the gaming experience.

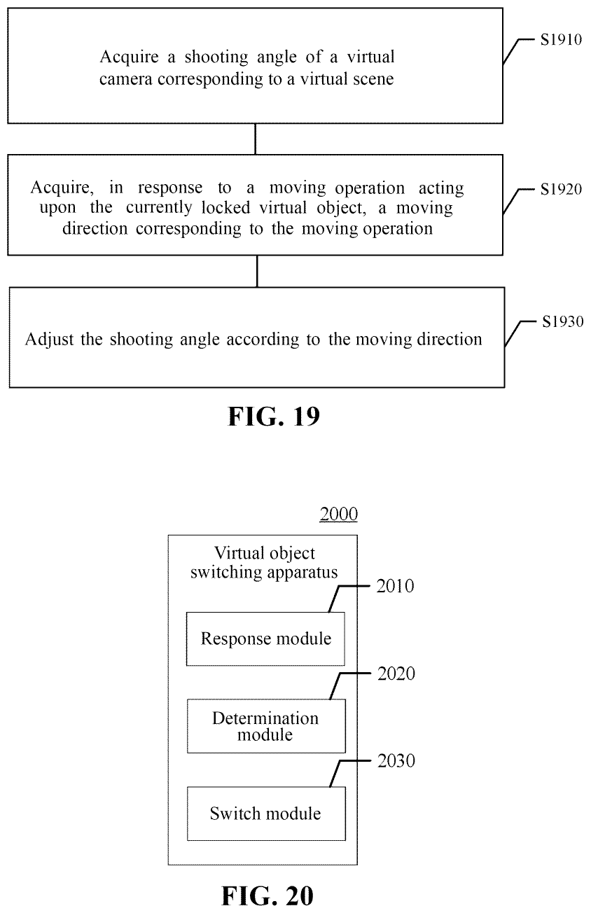

FIG. 19 shows a schematic flowchart of adjusting a shooting angle in a virtual object switching method. As shown in FIG. 19, the method includes at least the following steps: in step S1910, a shooting angle of a virtual camera corresponding to a virtual scene is acquired.

The virtual camera refers to a camera corresponding to the virtual scene and determining the virtual scene displayed on the graphical user interface.

For example, it is determined that the shooting angle of the virtual camera corresponding to the virtual scene is 0 at this time. 0 corresponds to a due north direction of the virtual scene.

In step S1920, in response to a moving operation acting upon the currently locked virtual object, a moving direction corresponding to the moving operation is acquired.

The moving operation refers to an operation that can control the movement of a currently locked virtual object. Specifically, the moving operation may directly act upon the currently locked virtual object, or it may act upon a mobile control corresponding to the currently locked virtual object, which is not specifically limited in this example embodiment.

For example, a moving operation is performed on the second virtual object, and it is determined that a moving direction corresponding to the moving operation is a north-east direction.

In step S1930, the shooting angle is adjusted according to the moving direction.

The shooting angle of the virtual camera is adjusted according to the moving direction.

For example, the moving direction is the north-east direction, and the shooting angle is 0; therefore, the shooting angle is adjusted from 0 to 315 according to the moving direction, so that the shooting angle of the virtual camera is consistent with the moving direction.

In this example embodiment, the shooting angle is adjusted according to the moving direction to ensure that the shooting angle of the virtual camera is consistent with the moving direction of the currently locked virtual object, so that the currently locked virtual object is always displayed at a specific position in the virtual scene.

In some embodiments, the method further includes: displaying a locking indicator at a preset position corresponding to the currently locked virtual object.

The preset position refers to the position corresponding to the currently locked virtual object. Specifically, the preset position may be a position above the currently locked virtual object, a position below the currently locked virtual object, a position at right of the currently locked virtual object, a position at left of the currently locked virtual object, or a position of a certain part of the body of the currently locked virtual object, which is not specifically limited in this example embodiment.

A locking indicator functions to remind the user that the enemy virtual object is the currently locked virtual object. Specifically, the locking indicator may be a graphic, a number, or a letter, which is not specifically limited in this example embodiment.

For example, the locking indicator is displayed at the exact center of the body of the currently locked virtual object.

In this example embodiment, the locking indicator is displayed at the preset position of the currently locked virtual object, which helps prompt the user which enemy virtual object is locked, thereby optimizing the gaming experience of the user.

In some embodiments, the method further includes: canceling, in response to a third touch operation acting upon the function control, the locking of the currently locked virtual object.

The third touch operation is different from the first touch operation, the second touch operation, and the control operation. Specifically, the third touch operation may be a long press operation, a double-click operation, or any operation that is different from the first touch operation, the second touch operation, and the control operation, which is not specifically limited in this example embodiment.

When the user performs the third touch operation on the function control, the locking of the currently locked virtual object will be canceled.

For example, the currently locked virtual object is a second virtual object X4. When the user long presses the function control, the locking of the second virtual object X4 is canceled.

In this example embodiment, when the third touch operation is performed on the lock control, the locking of the currently locked virtual object is canceled, which meets the user's need to cancel the lock and improves the user experience.

In the method and apparatus provided by the example embodiments of the present disclosure, on the one hand, the second virtual object is determined according to the operation direction based on the first position information of the currently locked first virtual object, the situation in the prior art that a virtual object is randomly locked but the randomly locked virtual object is not the user's intended locked object is avoided, thereby improving user experience. On the other hand, the second virtual object is determined based on the first position information and the operation direction, based on which the second virtual object is related to the operation direction and the first position information, thereby improving the accuracy of the determined second virtual object, and avoiding the situation in the prior art that the virtual object may be switched to a virtual object outside the field of view of the virtual object.

A detailed description is made for the virtual object switching method according to the embodiments of the present disclosure below in conjunction with an application scenario.

In a game interface of a shooting game, the currently locked first virtual object is a virtual object A. At this time, when a user slides on the function (a sliding direction is an upper right direction), the second virtual object is then determined to be a virtual object B based on first position information of the first virtual object A and the sliding direction, and the currently locked virtual object is switched from the first virtual object A to the second virtual object B.

In this application scenario, on the one hand, the second virtual object is determined according to the operation direction based on the first position information of the currently locked first virtual object, and the situation in the prior art that a virtual object is randomly locked but the randomly locked virtual object is not the user's intended locked object is avoided, thereby improving user experience. On the other hand, the second virtual object is determined based on the first position information and the operation direction, based on which the second virtual object is related to the operation direction and the first position information, thereby improving the accuracy of the determined second virtual object, and avoiding the situation in the prior art that the virtual object may be switched to a virtual object outside the field of view of the virtual object.

In addition, in an example embodiment of the present disclosure, a display device for a virtual object is further provided. FIG. 20 shows a schematic structural diagram of a virtual object switching apparatus. As shown in FIG. 20, the virtual object switching apparatus 2000 may include: a response module 2010, a determination module 2020, and a switch module 2030.

The response module 2010 is configured to determine, in response to a control operation acting upon a function control, an operation direction corresponding to the control operation, where the function control is located on a graphical user interface; the determination module 2020 is configured to determine, based on first position information of a currently locked first virtual object, a second virtual object according to the operation direction, where the currently locked first virtual object is the behavior target of the virtual character; and the switch module 2030 is configured to switch the currently locked first virtual object to the second virtual object.

The specific details of the above virtual object switching apparatus 2000 have been described in detail in the corresponding virtual object switching method, and thus will not be repeated here.

It should be noted that although several modules or units of the virtual object switching apparatus 2000 are mentioned in the above detailed description, such division is not mandatory. Actually, according to the embodiments of the present disclosure, the features and functions of two or more modules or units described above may be embodied in one module or unit. Conversely, the feature and function of a module or unit described above may be further divided to be embodied by a plurality of modules or units

In addition, in an example embodiment of the present disclosure, an electronic device capable of implementing the above method is further provided.

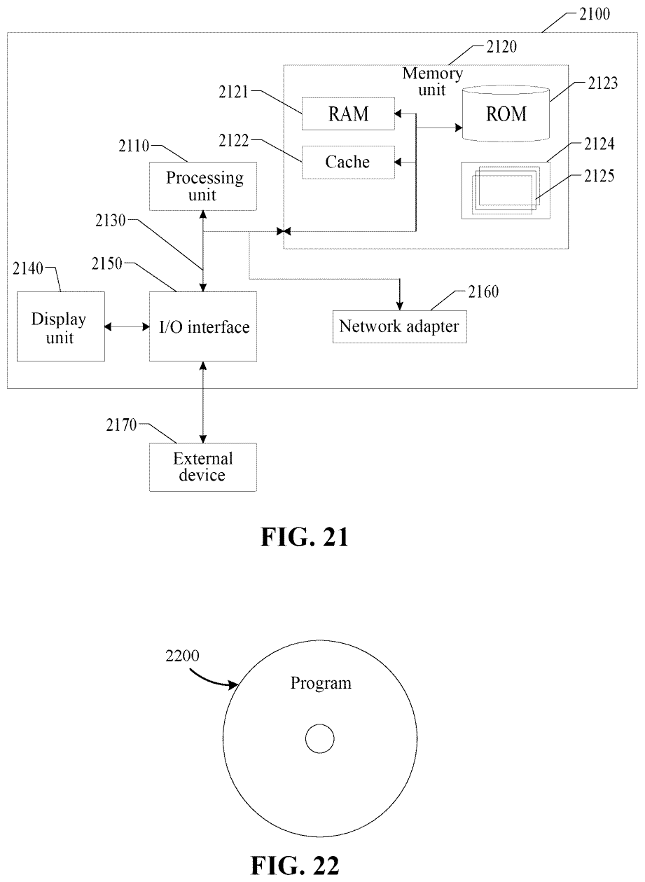

An electronic device 2100 according to such an embodiment of the present disclosure is described below with reference to FIG. 21. The electronic device 2100 shown in FIG. 21 is merely an example and should not limit the functions and scope of use of the embodiments of the present disclosure.

As shown in FIG. 21, the electronic device 2100 is embodied in the form of a general-purpose computing device. Components of the electronic device 2100 may include, but are not limited to: the at least one processing unit 2110, the at least one memory unit 2120, a bus 2130 connecting different system components (including the memory unit 2120 and the processing unit 2110), and a display unit 2140.

The memory unit stores program codes, and the program codes may be executed by the processing unit 2110, so that the processing unit 2110 performs the steps described in the above “example method” part of this specification according to various example embodiments of the present disclosure.

The memory unit 2120 may include a readable medium in the form of a volatile memory unit, such as a random access memory unit (RAM) 2121 and/or a cache memory unit 2122, and may further include a read-only memory unit (ROM) 2123.

The memory unit 2120 may also include a program/utility 2124 having a set (at least one) of program modules 2125, the program modules 2125 including but not limited to: an operating system, one or a plurality of application programs, other program modules, and program data, each of the examples or a combination thereof may include an implementation of a network environment.

The bus 2130 may represent one or a plurality of several types of bus structures, including a memory unit bus or a memory unit controller, a peripheral bus, an accelerated graphics port, a processing unit, or a local bus using any bus structure of a variety of bus structures.

In some embodiments, the electronic device 2100 may also communicate with one or a plurality of external devices 2170 (such as a keyboard, a pointing device, and a Bluetooth device), with one or a plurality of devices that enable a user to interact with the electronic device 2100, and/or with any device (such as a router and a modem) that enables the electronic device 2100 to communicate with one or a plurality of other computing devices. Such communications may be performed through an input/output (I/O) interface 2150. Furthermore, the electronic device 2100 may also communicate with one or a plurality of networks (for example, a local area network (LAN), a wide area network (WAN), and/or a public network, such as the Internet) through a network adapter 2160. As shown in the figure, the network adapter 2160 communicates with other modules of the electronic device 2100 through the bus 2130. It should be understood that although not shown in the figure, other hardware and/or software modules may be used in conjunction with the electronic device 2100, including but not limited to: microcodes, device drivers, redundant processing units, external disk drive arrays, RAID systems, tape drives, data backup storage systems, and the like.

Through the description of the above embodiments, those skilled in the art can easily understand that the example embodiments described here may be implemented by software, or by combining software with necessary hardware. Therefore, the technical solution according to the embodiment of the present disclosure may be embodied in the form of a software product, and the software product may be stored in a non-volatile storage medium (which may be a CD-ROM, a USB flash drive, a mobile hard disk, and the like) or on a network, and includes a number of instructions to enable a computing device (which may be a personal computer, a server, a terminal device, or a network device, and the like) to perform the method according to the embodiments of the present disclosure.

In an example embodiment of the present disclosure, a computer-readable storage medium is further provided, on which a program product capable of implementing the above method of this specification is stored. In some possible embodiments, various aspects of the present disclosure may also be implemented in the form of a program product, which includes program code. When the program product is run on a terminal device, the program code is used to enable the terminal device to perform the steps of various example embodiments of the present disclosure described in the above “example method” part of this specification.

Referring to FIG. 22, a program product 2200 for implementing the above method according to an embodiment of the present disclosure is described, which may adopt a portable compact disk read-only memory (CD-ROM) and include program code, and may be run on a terminal device, such as a personal computer. However, the program product of the present disclosure is not limited thereto, and in this file, the readable storage medium may be any physical medium including or storing a program, and the program may be used by or in combination with an instruction execution system, an apparatus, or a device.

The program product may use any combination of one or more readable mediums. The readable medium may be a readable signal medium or a readable storage medium. The readable storage medium may be, for example, but not limited to, an electronic, magnetic, optical, electromagnetic, infrared, or semiconductor system, apparatus or device, or a combination of any of the above. More detailed examples (a non-exhaustive list) of the readable storage medium include: an electric connection provided with one or more leads, a portable magnetic disk, a hard disk, a random access memory (RAM), a read only memory (ROM), an erasable and programmable read only memory (EPROM or flash memory), an optical fiber, a portable compact disk read only memory (CD-ROM), an optical storage device, a magnetic storage device, or any suitable combination thereof.

The computer readable signal medium may include a data signal propagated in a baseband or as a portion of a carrier, and the data signal carries a readable program code. The propagated data signal may have various forms, including but not limited to, an electromagnetic signal, an optical signal, or any suitable combination of the above. The readable signal medium may further be any readable medium other than the readable storage medium, and the readable medium may send, propagate or transmit a program used by or in combination with an instruction execution system, an apparatus or a device.

The code included in the computer readable medium may be transmitted by using any suitable medium, including, but not limited to, wireless, wired, optical cables, RF, and the like, or any suitable combination of the above.

The program code for executing the operation of the present disclosure may be written by using any combination of one or more program design languages, and the program design language includes an object-oriented program design language, such as Java and C++, and also includes regular procedural program design language, such as “C” language, or a similar program design language. The program codes may be executed completely on a user computing device, partially on a user equipment, as an independent software packet, partially on a user computing device and partially on a remote computing device, or completely on a remote computing device or a server. In a case where a remote computing device is involved, the remote computing device can be connected to a user computing device through any kind of networks, including a local area network (LAN) or a wide area network (WAN), or can be connected to an external computing device (for example, connected through the Internet using an Internet service provider).

Those skilled in the art can easily obtain other embodiments of the present disclosure after considering the specification and practicing the invention disclosed here. The present disclosure is intended to cover any variations, usages, or adaptive changes of the present disclosure, and these variations, usages, or adaptive changes follow general principles of the present disclosure and include common general knowledge or conventional technical measures in this technical field that are not disclosed in the present disclosure. The specification and embodiments are considered as merely exemplary, and real scope and spirit of the present disclosure are defined by the following claims.

1. A virtual object switching method, and the method comprises:
determining, in response to a control operation acting upon a function control, an operation direction corresponding to the control operation, wherein the function control is located on a graphical user interface provided by a terminal device, the graphical user interface comprises at least a portion of a virtual scene and at least a portion of a virtual character, and the virtual character is a virtual object corresponding to the terminal device;
determining, based on first position information of a locked first virtual object, a second virtual object according to the operation direction, wherein the locked first virtual object is a behavior target of the virtual character; and
switching the locked first virtual object to the second virtual object.

2. The virtual object switching method according to claim 1, wherein determining, based on the first position information of the locked first virtual object, the second virtual object according to the operation direction comprises:
determining the first position information corresponding to the locked first virtual object, and determining a target region based on the first position information and the operation direction; and
determining one or more region objects in the target region to determine the second virtual object among the one or more region objects.

3. The virtual object switching method according to claim 1, wherein determining, based on the first position information of a the locked first virtual object, the second virtual object according to the operation direction comprises:
establishing, by taking the first position information as an endpoint, a target ray consistent with the operation direction; and
determining one or more ray virtual objects on the target ray to determine the second virtual object among the one or more ray virtual objects.

4. The virtual object switching method according to claim 2, wherein the target region comprises a sector region; and
determining the target region based on the first position information and the operation direction comprises:
establishing, by taking the first position information as an endpoint, a region ray consistent with the operation direction; and
constructing, by taking the first position information as an center point, the sector region with a central angle being a preset angle based on the region ray.

5. The virtual object switching method according to claim 4, wherein determining the one or more region objects in the target region to determine the second virtual object among the one or more region objects comprises:
determining, in response to the existence of a first region object in the sector region, a number of the region objects to obtain a number determination result;
determining, in response to the number determination result being one, the first region object as the second virtual object; and
determining, in response to the number determination result being multiple, object position information corresponding to a plurality of region objects, and determining a second virtual object among the plurality of region objects according to a position distance between the object position information and the first position information.

6. The virtual object switching method according to claim 4, wherein determining the one or more region objects in the target region to determine the second virtual object among the one or more region objects comprises:
enlarging, in response to no region object existing in the sector region, the preset angle to update the sector region;
determining whether the region object exists in the updated sector region to obtain an object determination result; and
determining a second virtual object in the sector region according to the object determination result.

7. The virtual object switching method according to claim 6, wherein enlarging, in response to no region object existing in the sector region, the preset angle to update the sector region comprises:
incrementing the preset angle according to a preset angle increment parameter to update the sector region.

8. The virtual object switching method according to claim 6, wherein the method further comprises:
changing, in response to the enlarged preset angle meeting a preset angle condition and no region object existing in the sector region corresponding to the enlarged preset angle, a direction of the region ray from being consistent with the operation direction to being opposite to the operation direction to update the region ray.

9. The virtual object switching method according to claim 1, wherein the method further comprises:
acquiring a position direction of a locked virtual object relative to the virtual character, and determining an attack direction corresponding to the virtual character, wherein the locked virtual object is the locked first virtual object or the second virtual object; and
adjusting, based on the position direction, the attack direction to make the adjusted attack direction corresponds to the locked virtual object.

10. The virtual object switching method according to claim 9, wherein the method further comprises:
acquiring a shooting angle of a virtual camera corresponding to the virtual scene;
acquiring, in response to a moving operation acting upon the locked virtual object, a moving direction corresponding to the moving operation; and
adjusting the shooting angle according to the moving direction.

11. The virtual object switching method according to claim 1, wherein the method further comprises:
displaying a locking indicator at a preset position corresponding to the locked first virtual object.

12. The virtual object switching method according to claim 1, wherein before determining, in response to the control operation acting upon the function control, the operation direction corresponding to the control operation, the method further comprises:
determining, in response to a first touch operation acting upon the function control, screen position information corresponding to the graphical user interface;
determining object position information of an enemy virtual object displayed in the graphical user interface, and calculating the object position information and the screen position information to obtain a position calculation result; and
determining, according to the position calculation result, a first virtual object among the enemy virtual objects, and determining the first virtual object as the locked first virtual object.

13. The virtual object switching method according to claim 12, wherein the screen position information comprises position information corresponding to a center of the graphical user interface, crosshair position information, and character position information corresponding to the virtual character.

14. The virtual object switching method according to claim 12, wherein after determining the first virtual object as the locked first virtual object, the method further comprises:
determining, in response to a second touch operation acting upon the function control, a target enemy virtual object displayed in the graphical user interface, wherein the target enemy virtual object does not comprise the first virtual object; and
using one of the target enemy virtual objects as the second virtual object, and switching the locked first virtual object to the second virtual object.

15. The virtual object switching method according to claims 9, wherein the method further comprises:
canceling, in response to a third touch operation acting upon the function control, a locking of the locked virtual object.

16. (canceled)

17. A system, comprising:
one or more memories collectively containing one or more programs; and
one or more processors, wherein the one or more processors are configured to, individually or collectively, perform an operation comprising:
determining, in response to a control operation acting upon a function control, an operation direction corresponding to the control operation, wherein the function control is located on a graphical user interface provided by a terminal device, the graphical user interface comprises at least a portion of a virtual scene and at least a portion of a virtual character, and the virtual character is a virtual object corresponding to the terminal device;
determining, based on first position information of a locked first virtual object, a second virtual object according to the operation direction, wherein the locked first virtual object is a behavior target of the virtual character; and
switching the locked first virtual object to the second virtual object.

18. One or more non-transitory computer-readable storage media containing, in any combination, computer program code that, when executable by a computer system, perform an operation comprising:
determining, in response to a control operation acting upon a function control, an operation direction corresponding to the control operation, wherein the function control is located on a graphical user interface provided by a terminal device, the graphical user interface comprises at least a portion of a virtual scene and at least a portion of a virtual character, and the virtual character is a virtual object corresponding to the terminal device;
determining, based on first position information of a locked first virtual object, a second virtual object according to the operation direction, wherein the locked first virtual object is a behavior target of the virtual character; and
switching the locked first virtual object to the second virtual object.

19. The system according to claim 17, wherein determining, based on the first position information of the locked first virtual object, the second virtual object according to the operation direction comprises:
determining the first position information corresponding to the locked first virtual object, and determining a target region based on the first position information and the operation direction; and
determining one or more region objects in the target region to determine the second virtual object among the one or more region objects.

20. The system according to claim 17, wherein the operation further comprises:
acquiring a position direction of a locked virtual object relative to the virtual character, and determining an attack direction corresponding to the virtual character, wherein the locked virtual object is the locked first virtual object or the second virtual object; and
adjusting, based on the position direction, the attack direction to make the adjusted attack direction corresponds to the locked virtual object.

21. The system according to claim 17, wherein, before determining, in response to the control operation acting upon the function control, the operation direction corresponding to the control operation, the operation further comprises:
determining, in response to a first touch operation acting upon the function control, screen position information corresponding to the graphical user interface;
determining object position information of an enemy virtual object displayed in the graphical user interface, and calculating the object position information and the screen position information to obtain a position calculation result; and
determining, according to the position calculation result, a first virtual object among the enemy virtual objects, and determining the first virtual object as the locked first virtual object.
